(19) United States
(12) Patent Application Publication
(10) Pub. No.: US 2026/0246910 A1
(43) Pub. Date: Aug. 20, 2026

(54) INFORMATION PROCESSING DEVICE, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventors: MASATO AKAO, TOKYO (JP); SHIHHAO WEN, TOKYO (JP)

(21) Appl. No.: 18/876,710

(22) PCT Filed: Jun. 19, 2023
(86) PCT No.: PCT/JP2023/022635

§ 371 Date: Dec. 19, 2024

(30) Foreign Application Priority Data
Jun. 28, 2022 (JP) 2022-103344

(51) Int. Cl. H04N 13/322; G06T 7/00; H04N 13/128

(52) U.S. Cl. CPC H04N 13/322; G06T 7/0002; H04N 13/128

(57) ABSTRACT

An information processing device includes a wavefront reproduction control unit and a lens control unit. The wavefront reproduction control unit reproduces an object area to be reproduced in an appropriate range in a depth direction in which range reproduction image quality equal to or higher than an image quality allowable level is acquired. The lens control unit moves a reproduced image reproduced in the appropriate range to a depth position of the object area.

### FIELD

The present invention relates to an information processing device, an information processing method, and a computer-readable non-transitory storage medium.

### BACKGROUND

Various stereoscopic reproduction methods have been studied for natural depth representation. As one of them, a wavefront reproduction-type reproduction method using a computer-generated hologram is known. This method is to display an interference fringe on a display, cause the interference fringe to interfere with reference light, and reproduce an arbitrary wavefront. However, since image quality deteriorates as a distance from a display surface increases, a reproducible depth range is narrow.

### CITATION LIST

### Non Patent Literature

Non Patent Literature 1: Multifocal displays: review and prospect, Zhan et al., PhotoniX (2020)

### SUMMARY

### Technical Problem

As another method, a volume-type stereoscopic reproduction method using a variable focus lens is also known. This method is to sample a 3D object in a depth direction and to rearrange a plurality of sampled 2D images (layers) in a time-division manner by the variable focus lens. In this method, although a focal length of the variable focus lens needs to be switched in short time, the focal length switching speed is limited. Thus, the number of layers that can be reproduced is reduced, and natural depth representation cannot be acquired.

Thus, the present disclosure proposes an information processing device, information processing method, and computer-readable non-transitory storage medium capable of performing natural depth representation with high image quality.

### Solution to Problem

According to the present disclosure, an information processing device is provided that comprise: a wavefront reproduction control unit that reproduces an object area to be reproduced in an appropriate range in a depth direction in which range reproduction image quality equal to or higher than an image quality allowable level is acquired; and a lens control unit that moves a reproduced image reproduced in the appropriate range to a depth position of the object area. According to the present disclosure, an information processing method in which an information process of the information processing device is executed by a computer, and a computer-readable non-transitory storage medium that stores a program causing a computer to perform the information process of the information processing device, are provided.

### BRIEF DESCRIPTION OF DRAWINGS

FIG. 1 is a view for describing a problem in a case of reproducing a stereoscopic image by using wavefront reproduction.

FIG. 2 is a view for describing a reproduction method in which the wavefront reproduction and a variable focus lens are combined.

FIG. 3 is a view illustrating a result of a comparison between a reproduction method of the present disclosure and a conventional reproduction method.

FIG. 4 is a view illustrating an example of a configuration of a stereoscopic image system.

FIG. 5 is a view illustrating an example of a data flow.

FIG. 6 is a flowchart illustrating a flow of entire processing.

FIG. 7 is a view illustrating an example of scene configuration data generation processing.

FIG. 8 is a view illustrating the example of the scene configuration data generation processing.

FIG. 9 is a view illustrating a configuration example of the scene configuration data.

FIG. 10 is a view illustrating an example of scene reproduction data generation processing.

FIG. 11 is a view illustrating the example of the scene reproduction data generation processing.

FIG. 12 is a view illustrating a configuration example of the scene reproduction data.

FIG. 13 is a view illustrating an example of wavefront reproduction data generation processing.

FIG. 14 is a view illustrating a configuration example of the wavefront reproduction data.

FIG. 15 is a view illustrating an example of lens reproduction data generation processing.

FIG. 16 is a view illustrating a configuration example of the lens reproduction data.

FIG. 17 is a view illustrating an example of control of a wavefront reproduction medium.

FIG. 18 is a view illustrating an example of control of a lens medium.

FIG. 19 is a view illustrating a modification example of scene configuration data generation processing.

FIG. 20 is a view illustrating a modification example of wavefront reproduction data generation processing.

FIG. 21 is a view illustrating a modification example of wavefront reproduction data generation processing.

FIG. 22 is a view illustrating a hardware configuration example of an information processing device.

### DESCRIPTION OF EMBODIMENTS

In the following, embodiments of the present disclosure will be described in detail on the basis of the drawings. In each of the following embodiments, overlapped description is omitted by assignment of the same reference sign to the same parts.

Note that the description will be made in the following order.
[1. Summary of the invention]
[1-1. Background]
[1-2. Combination of wavefront reproduction and a variable focus lens]
[2. Configuration of a stereoscopic image system]
[3. Information processing method]
[3-1. Entire processing flow]
[3-2. Scene analysis]
[3-3. Scene reproduction control]
[3-4. Wavefront reproduction control]
[3-5. Lens control]
[3-6. Control of a wavefront reproduction medium]
[3-7. Control of a lens medium]
[4. Effect]
[5. First modification example]
[6. Second modification example]
[7. Third modification example]
[8. Hardware configuration example]

### 1. Summary of the Invention

### 1-1. Background

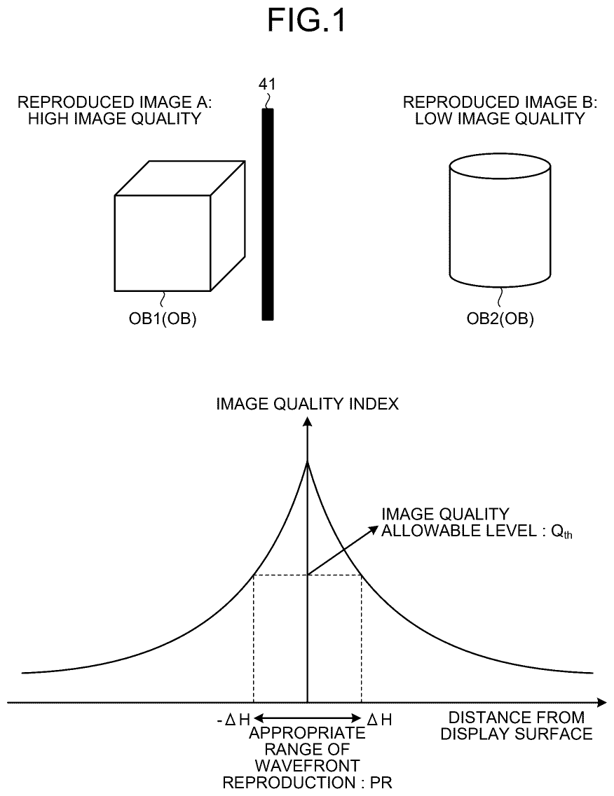

Hereinafter, a summary of the invention will be described with reference to FIG. 1 to FIG. 3. FIG. 1 is a view for describing a problem in a case of reproducing a stereoscopic image by using wavefront reproduction.

The wavefront reproduction-type stereoscopic image system displays an interference fringe on a display 41, and reproduces an arbitrary wavefront by causing the displayed interference fringe to interfere with reference light. As the display 41, an LCOS-SLM (spatial light modulator using a liquid crystal) is often used. In a case of a phase modulation, it is necessary to increase a thickness of a liquid crystal layer in order to secure a modulation width of 2π, and crosstalk between pixels and deterioration of time responsiveness are likely to be generated. Specifically, since reproduction image quality of a reproduced image rapidly deteriorates as a distance from a display screen (display surface) of the display increases, a range in a depth direction (depth range) that can be practically used is limited. Note that the depth direction means a direction orthogonal to the display surface.

An appropriate range PR of the wavefront reproduction is illustrated in FIG. 1. The appropriate range PR is defined as a depth range in which reproduction image quality equal to or higher than an image quality allowable level Qₜₕ is acquired by the wavefront reproduction. The image quality allowable level Qₜₕ means minimum reproduction image quality determined by a specification (required performance) of the system, or the like. In the example of FIG. 1, the appropriate range PR is a range in which the distance from the display surface is ΔH or shorter. Although a reproduced image A of an object OB1 within the appropriate range PR has high image quality, a reproduced image B of an object OB2 outside the appropriate range PR has low image quality. The present disclosure proposes a method of improving narrowness of a reproduction range in wavefront reproduction by using a variable focus lens.

### 1-2. Combination of Wavefront Reproduction and a Variable Focus Lens

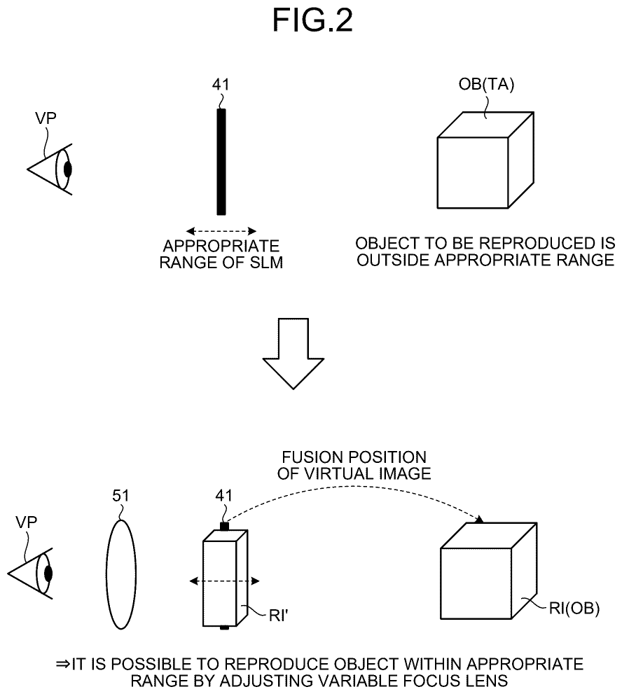

FIG. 2 is a view for describing a reproduction method in which wavefront reproduction and a variable focus lens 51 are combined.

In the present disclosure, coordinate data of an object area TA to be reproduced (object OB in the example of FIG. 2) is transformed in such a manner that the object area TA falls within the appropriate range PR. Then, wavefront data of the object area TA is generated by utilization of the transformed coordinate data. In the example of FIG. 2, transformation of the coordinate data in which transformation a center of the object OB becomes an origin is performed. By performing wavefront reproduction using the transformed coordinate data, it is possible to acquire a reproduced image RI′ having a predetermined depth centered on the display 41. The reproduced image RI′ is shifted in the depth direction by the variable focus lens 51, and is recognized as a reproduced image RI.

In this method, the high image quality reproduced image RI′ reproduced in the appropriate range PR is rearranged at an appropriate position in the depth direction (depth position) by the variable focus lens 51. Thus, natural depth representation with high image quality is acquired. Although the entire object OB is reproduced in the appropriate range PR in the example of FIG. 2, the entire object OB cannot be reproduced in the appropriate range PR in a case where the object OB is large. In this case, the object OB may be divided into a plurality of the object areas TA, and the reproduced image RI′ of each of the object areas TA may be displayed in a time-division manner while a focal length of the variable focus lens 51 is changed.

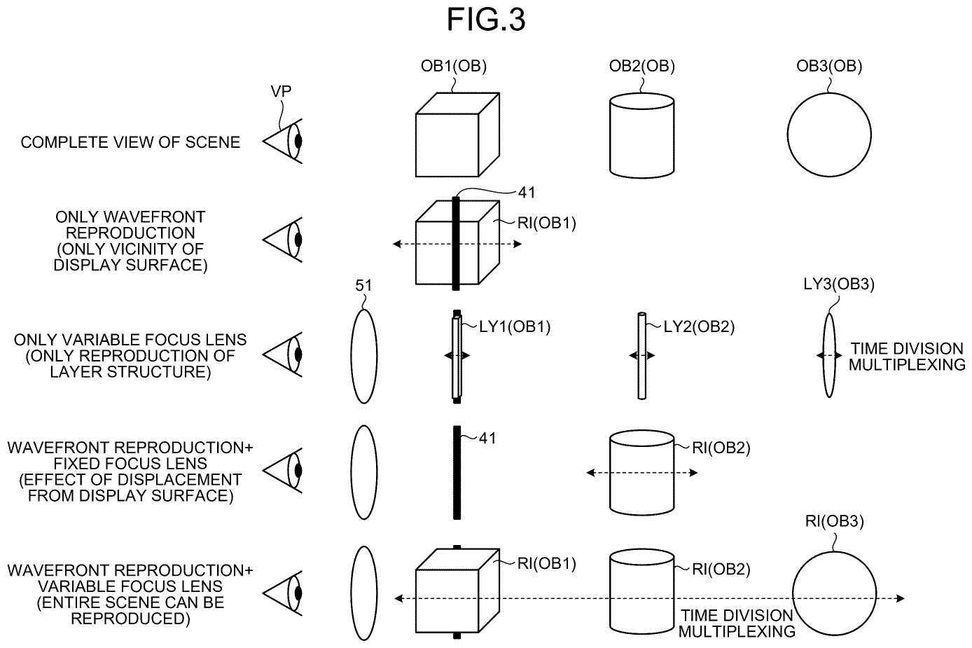

FIG. 3 is a view illustrating a result of a comparison between a reproduction method of the present disclosure and a conventional reproduction method.

A scene to be reproduced includes a plurality of objects OB. Although an object OB1 closest to a viewpoint VP is placed within the appropriate range PR, an object OB2 and an object OB3 are placed outside the appropriate range PR. As illustrated in a second row of FIG. 3, only the object OB1 in the appropriate range PR is appropriately reproduced by the method using only the wavefront reproduction.

As illustrated in a third row of FIG. 3, a volume-type stereoscopic reproduction method using the variable focus lens 51 is also known. In this method, a scene is sampled in the depth direction, whereby a plurality of 2D images (layers LY) is generated. The generated plurality of 2D images is rearranged in the depth direction in the time-division manner by the variable focus lens 51. However, since a speed of changing the focal length is limited, the number of layers LY that can be reproduced is small. Thus, natural depth representation cannot be acquired. In addition, there is also a problem that only a scene having a layer structure can be reproduced.

As illustrated in a fourth row of FIG. 3, a method of combining the wavefront reproduction with a fixed focus lens is also conceivable. However, only a specific object OB2 corresponding to the focal length is appropriately reproduced by this method. On the other hand, all the objects OB are reproduced with high image quality regardless of the distance by the method of the present disclosure illustrated in a fifth row of FIG. 3.

### 2. Configuration of a Stereoscopic Image System

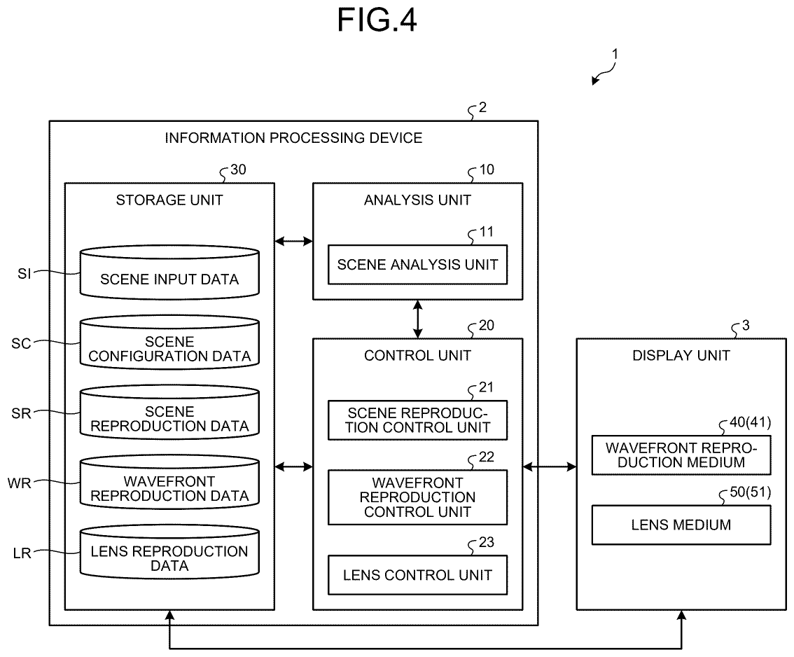

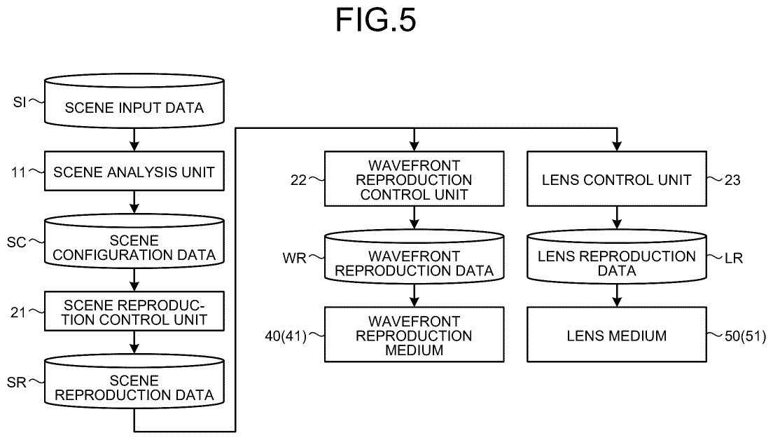

FIG. 4 is a view illustrating an example of a configuration of a stereoscopic image system 1. FIG. 5 is a view illustrating an example of a data flow.

The stereoscopic image system 1 is a system that three-dimensionally reproduces a 3D scene by using a computer-generated hologram. The stereoscopic image system 1 includes an information processing device 2 and a display unit 3.

The hologram records an interference fringe formed by interference between object light scattered by an object OB and reference light having high coherency, such as a laser. When illumination light having the same amplitude and phase as those of the reference light is emitted to the hologram, object light is reproduced by diffraction of the light. The stereoscopic image system 1 reproduces a stereoscopic image of the object OB by outputting the data of the interference fringe (wavefront data) calculated by the information processing device 2 to the display unit 3.

### <<A. Display Unit>>

The display unit 3 presents the reproduced image RI in a three-dimensional space on the basis of the wavefront data acquired from the information processing device 2. The display unit 3 includes a wavefront reproduction medium 40 and a lens medium 50.

The wavefront reproduction medium 40 is a medium on which the interference fringe is recorded. By emission of the reference light to the interference fringe, the reproduced image RI′ is reproduced. The wavefront reproduction medium 40 is acquired, for example, by displaying of the interference fringe on the display 41. The display 41 can display any interference fringe. Switching of the interference fringe is treated as switching of the wavefront reproduction medium 40. The display unit 3 can switch and display a plurality of the reproduced images RI′ in a time division manner by switching and displaying a plurality of the interference fringes in the time division manner.

The lens medium 50 moves a reproduction position of the reproduced image RI′. The lens medium 50 includes the variable focus lens 51 a focal length of which can be variably controlled. The focal length is switched electrically or mechanically. As the variable focus lens 51, a known lens such as a liquid crystal lens is used. The lens medium 50 can change the reproduction position of the reproduced image RI′ in a time division manner by switching the focal length of the variable focus lens 51 in the time division manner.

Although not illustrated, the display unit 3 includes a light source that emits the reference light to the wavefront reproduction medium 40, a display driving control unit that drives the wavefront reproduction medium 40, and a lens driving control unit that drives the lens medium 50.

### <<B. Information Processing Device>>

The information processing device 2 is a dedicated or general-purpose computer capable of controlling the display on the display unit 3. The information processing device 2 has a function of generating the wavefront data, and a function of rearranging the reproduced image RI. The information processing device 2 includes an analysis unit 10, a control unit 20, and a storage unit 30.

### <B-1. Storage Unit>

The storage unit 30 stores scene input data SI, scene configuration data SC, scene reproduction data SR, wavefront reproduction data WR, and lens reproduction data LR.

The scene input data SI is a set of Intensity (RGB pixel values) and distance data of each element included in a scene. The scene input data SI indicates a three-dimensional distribution of the RGB pixel values. The scene input data SI is prepared as data that defines the scene.

The scene configuration data SC is data in which the entire scene is expressed again in a layer configuration. The scene configuration data SC is generated on the basis of the scene input data SI. The layer LY means each of the 2D images acquired by sampling of the scene in the depth direction. The scene to be reproduced is expressed as a set of a plurality of the layers LY arranged in the depth direction.

The scene reproduction data SR is data in which the scene configuration data SC is classified for each of the wavefront reproduction media 40 (interference fringes) and a time code is added. The time code is acquired by encoding of switching timing of the wavefront reproduction media 40 (interference fringes).

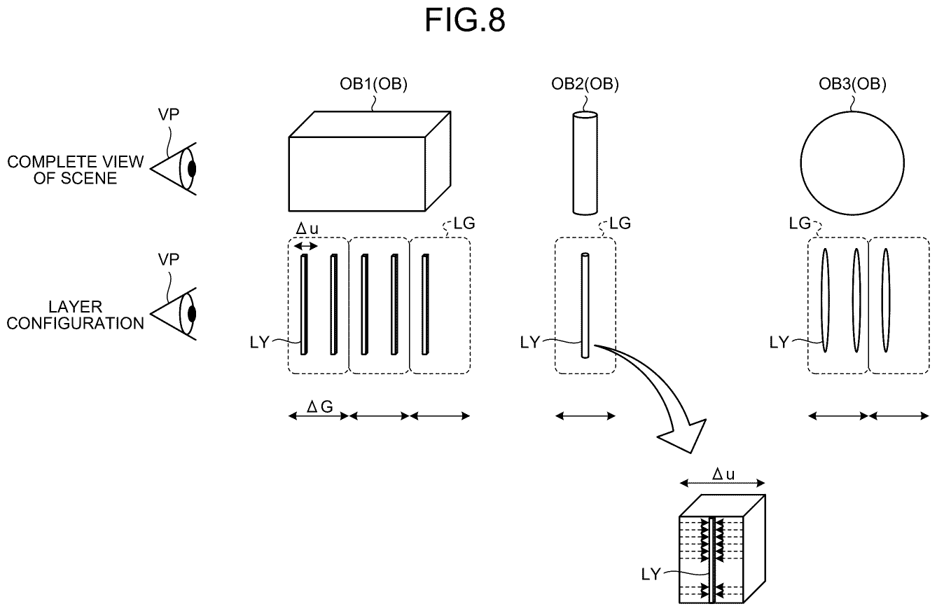

Although details will be described later, the plurality of layers LY is classified into one or more layer groups LG (see FIG. 8) in the depth direction. The interference fringe is generated on the basis of the Intensity and the distance data of all the layers LY in each of the layer groups LG. The wavefront reproduction medium 40 (interference fringe) is prepared for each of the layer groups LG, and the reproduced image RI is generated for each of the layer groups LG. The scene reproduction data SR defines the Intensity and the distance data of each of the layer groups LG, and defines the reproduction timing of the layer group LG as the time code.

In the following description, the individual layer groups LG may be described in a distinguished manner as necessary. In a case where the individual layer groups LG are distinguished, numbers corresponding to arrangement order from a viewpoint VP are assigned after the reference sign of the layer groups LG. The same applies to a case where the layers LY are distinguished from each other or a case where configurations associated with the layer groups LG are distinguished from each other.

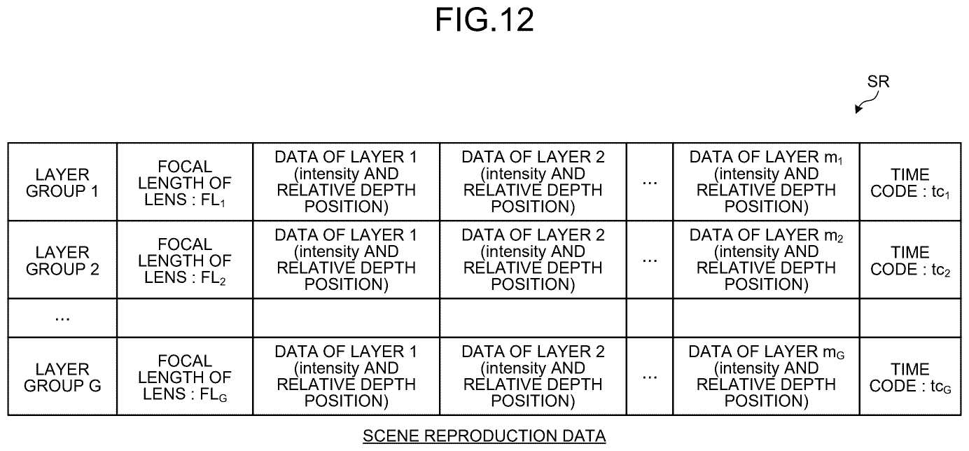

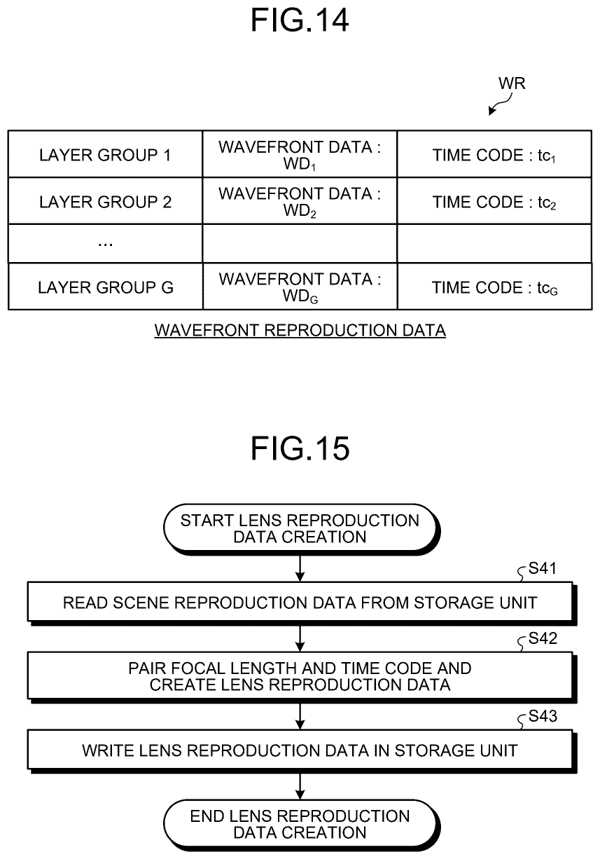

The wavefront reproduction data WR defines wavefront data WD (see FIG. 14) and a time code tc (see FIG. 12) for each of the layer groups LG. The wavefront reproduction data WR is generated on the basis of the scene reproduction data SR. The wavefront data WD indicates a distribution of complex amplitude (amplitude and phase) on the display surface. The wavefront data WD of each of the layer groups LG is generated by addition of the wavefront data of all the layers LY in the layer group LG. The wavefront data WD of the layer group LG is transmitted to the display 41, whereby the interference fringe corresponding to the layer group LG is displayed on the display surface.

Calculation of the wavefront data can be performed by utilization of the Rayleigh-Sommerfeld diffraction formula or high-speed calculation or approximate calculation method thereof (such as an angular spectrum method, Fresnel diffraction, or Fraunhofer diffraction). As a method of calculating the complex amplitude at a display medium position by iterative calculation, the Gerchberg-Saxton method and the like are also known.

The lens reproduction data LR defines a focal length FL of the variable focus lens 51 (see FIG. 12) and the time code tc for each of the layer groups LG. The lens reproduction data LR is generated on the basis of the scene reproduction data SR.

### <B-2. Analysis Unit>

The analysis unit 10 analyzes a scene to be reproduced on the basis of the scene input data SI. The analysis unit 10 includes a scene analysis unit 11. The scene analysis unit 11 generates the scene configuration data SC on the basis of the scene input data SI.

For example, the scene analysis unit 11 divides the scene to be reproduced into a plurality of layers LY in the depth direction. The scene analysis unit 11 groups the plurality of layers LY in the depth direction. The scene analysis unit 11 acquires each of layer groups LG acquired by the grouping as an object area TA. The object area TA means an area to be reproduced by the wavefront data WD.

The scene analysis unit 11 performs grouping in such a manner that each of the layer groups LG becomes an area having a depth equal to or shorter than a depth of the appropriate range PR. The scene analysis unit 11 calculates the depth positions of all the layers LY and all the layer groups LG. The scene analysis unit 11 outputs data of the calculated depth positions of all the layers LY and all the layer groups LG as the scene configuration data SC.

### <B-3. Control Unit>

The control unit 20 integrally controls components of the stereoscopic image system 1. The control unit 20 includes a scene reproduction control unit 21, a wavefront reproduction control unit 22, and a lens control unit 23.

The scene reproduction control unit 21 generates the scene reproduction data SR on the basis of the scene configuration data SC. For example, the scene reproduction control unit 21 calculates, for each of the layer groups LG, the focal length FL at the time of reproduction of the layer group LG and the time code tc indicating timing of changing the focal length FL on the basis of the depth position of the layer group LG.

The scene reproduction control unit 21 determines the depth position to be reference (reference depth position) for each of the layer groups LG. The scene reproduction control unit 21 calculates relative positions from the reference depth position (relative depth positions) of all the layers LY in each of the layer groups LG. By the calculation of the relative depth positions, transformation of coordinate data in which transformation coordinates of each of the layers LY are shifted in a horizontal direction is performed. The scene reproduction control unit 21 transforms the coordinate data of each of the layer groups LG in such a manner that the layer group LG falls within the appropriate range PR. The scene reproduction control unit 21 generates the scene reproduction data SR that defines the coordinate data after the transformation, the focal length FL, and the time code tc for each of the layer groups LG.

The wavefront reproduction control unit 22 acquires, from the scene reproduction data SR, the coordinate data of each of the layer groups LG on which coordinate data the coordinate transformation is performed on the basis of the reference depth position. The wavefront reproduction control unit 22 generates the wavefront data WD of each of the layer groups LG by using the transformed coordinate data. For example, the wavefront reproduction control unit 22 combines the wavefront data of each of the layers LY on the basis of the relative position of each of the layers LY in the layer group LG. The wavefront reproduction control unit 22 calculates the wavefront data acquired by the combination as the wavefront data WD of the layer group LG. As a result, the wavefront reproduction control unit 22 can reproduce the layer group LG to be reproduced in the appropriate range PR in the depth direction in which range the reproduction image quality equal to or higher than the image quality allowable level Qₜₕ can be acquired.

The lens control unit 23 determines the focal length FL of the variable focus lens 51 on the basis of the depth positions of the layer groups LG. As a result, the lens control unit 23 moves the reproduced image RI′ reproduced in the appropriate range PR to the depth positions of the layer groups LG. For example, the wavefront reproduction control unit 22 sequentially generates the reproduced image RI′ in the appropriate range PR while switching the layer groups LG to be reproduced in the depth direction. In accordance with the switching timing of the layer groups LG, the lens control unit 23 sequentially changes the focal length FL of the variable focus lens 51 that moves the reproduced image RI′.

### 3. Information Processing Method

### 3-1. Entire Processing Flow

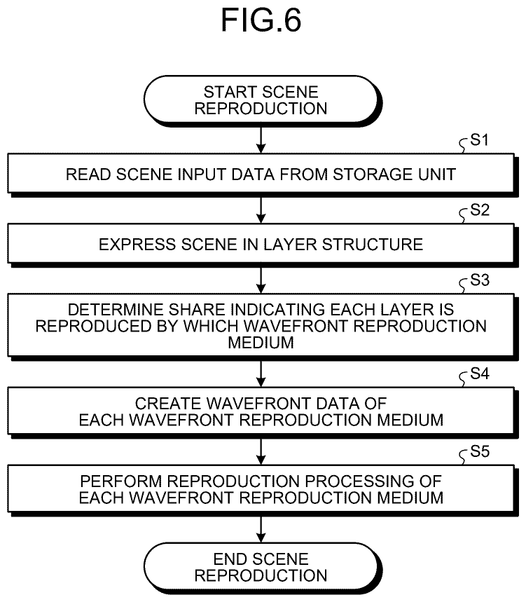

Hereinafter, information processing performed by the information processing device 2 will be specifically described. FIG. 6 is a flowchart illustrating a flow of the entire processing.

The analysis unit 10 reads the scene input data SI from the storage unit 30 (Step S1). The analysis unit 10 expresses a scene in a layer configuration (Step S2). The analysis unit 10 determines a share indicating each of the layers LY is reproduced by which wavefront reproduction medium 40 (that is, is allocated to which layer group LG) (Step S3). The analysis unit 10 generates, for each of the layer groups LG, the scene configuration data SC defining data (intensity and depth position) of each of the layers LY that belong to the layer group LG.

The control unit 20 generates wavefront data of each of the wavefront reproduction media 40 (layer groups LG) on the basis of the scene configuration data SC (Step S4), and performs reproduction processing of each of the wavefront reproduction media 40 (Step S5). For example, for each of the layer groups LG, the control unit 20 transforms the coordinate data of each of the layers LY that belong to the layer group LG on the basis of the reference depth position of the layer group LG. The control unit 20 generates the wavefront data WD of each of the layer groups LG by using the transformed coordinate data of each of the layers LY. The control unit 20 reproduces the wavefront data WD of each of the layer groups LG in the time division manner while switching the focal length FL of the variable focus lens 51 on the basis of the depth position of each of the layer groups LG.

Hereinafter, each of the steps will be specifically described.

### 3-2. Scene Analysis

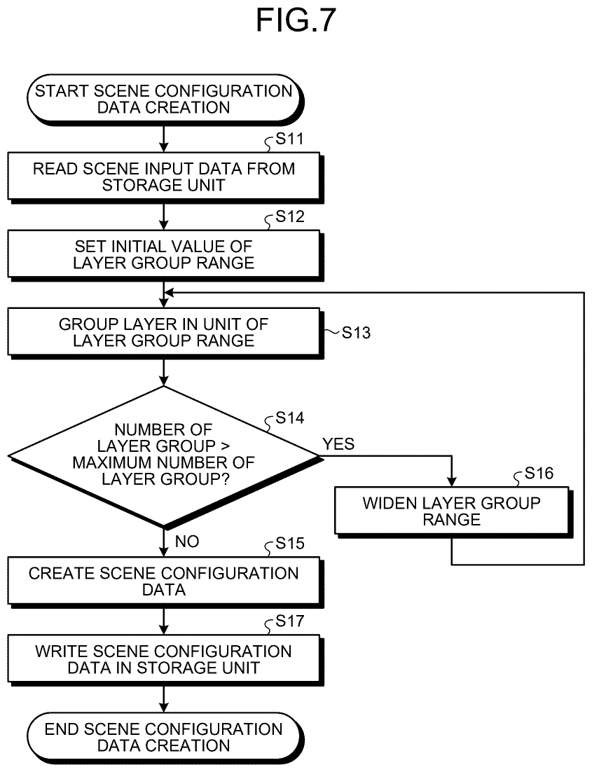

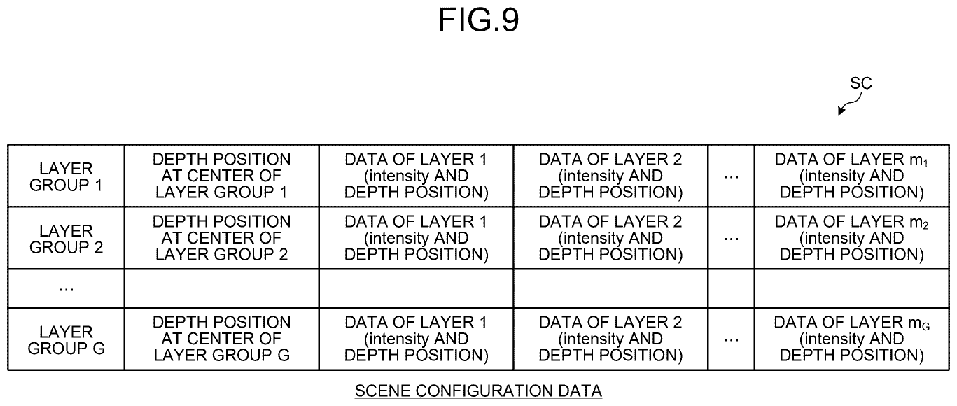

FIG. 7 and FIG. 8 are views illustrating an example of generation processing of the scene configuration data SC. FIG. 9 is a view illustrating a configuration example of the scene configuration data SC.

The scene analysis unit 11 reads the scene input data SI from the storage unit 30 (Step S11). The scene analysis unit 11 transforms the scene to be reproduced into a layer configuration (set of the layers LY). The scene analysis unit 11 divides a complete view of the scene into a plurality of unit areas Δu having a width, which is equal to or shorter than a detection limit, in the depth direction. The scene analysis unit 11 projects object light of each of the unit areas Δu onto a plane, and outputs a 2D image acquired by the projection as the layer LY. The scene analysis unit 11 divides the complete view of the scene into a plurality of the layers LY, and generates data (intensity and depth position) of each of the layers LY on the basis of the scene input data SI.

The scene analysis unit 11 sets an initial value of a layer group range ΔG (Step S12). The layer group range ΔG means a depth range of the layer groups LG. A group of layers within the layer group range ΔG is the layer group LG. The layer group range ΔG is set as a depth range in which the reproduction image quality equal to or higher than the image quality allowable level Qₜₕ can be acquired. For example, in the example of FIG. 1, the layer group range ΔG is set as a depth range in which a width in the depth direction is 2×ΔH or shorter. For example, the scene analysis unit 11 sets, as an initial value of the layer group range ΔG, a value arbitrarily designated by a system developer within this depth range.

For example, the layer group range ΔG is set in a unit of diopter. The scene analysis unit 11 can widen the layer group range ΔG as the layer group LG is farther from the viewpoint VP at which the scene is reproduced. As the layer group LG becomes farther from the viewpoint VP, it becomes difficult to distinguish the individual layers LY when the coordinate transformation is performed. However, when an interval between the layers LY is increased, the layers LY can be easily distinguished from each other.

The scene analysis unit 11 groups the plurality of layers LY included in the scene in a unit of the layer group range ΔG (Step S13). The scene analysis unit 11 determines whether the number of layer groups LG generated by the grouping is larger than a preset maximum number of layer groups (Step S14).

The maximum number of layer groups means the maximum allowable number of layer groups LG. For example, the maximum number of layer groups is set on the basis of reaction time (time until a change to a target refractive index is made and stability is acquired in a case of a liquid crystal lens) of the variable focus lens 51. For example, when it is assumed that one frame period is T_{F} and the reaction time of the variable focus lens 51 is T_{R}, the maximum number of layer groups is set as an integer equal to or smaller than T_{F}/T_{R}. In a case where the number of layer groups LG is equal to or smaller than the maximum number of layer groups LG, the reproduced images RI′ of all the layer groups LG can be sequentially rearranged and displayed in the depth direction within one frame period by the variable focus lens 51.

In a case where the number of layer groups LG is larger than the maximum number of layer groups (Step S14: Yes), the scene analysis unit 11 widens the layer group range ΔG by a preset update amount (Step S16), and returns to the grouping processing in Step S13. Then, the processing in and after Step S13 is repeated until the number of layer groups LG becomes equal to or smaller than the maximum number of layer groups. As a result, the scene analysis unit 11 sets the layer group range ΔG in such a manner that the number of layer groups LG is equal to or smaller than the preset maximum number of layer groups.

In a case where the number of layer groups LG is equal to or smaller than the maximum number of layer groups (Step S14: No), the scene analysis unit 11 determines a correspondence relationship between the layer groups LG and the layers LY. The scene analysis unit 11 generates the scene configuration data SC on the basis of the determined correspondence relationship (Step S15), and writes the scene configuration data SC in the storage unit 30 (Step S16). For each of the layer groups LG, the scene configuration data SC defines, for example, a depth position at the center of the layer group LG and data (intensity and depth position) of each of the layers LY that belong to the layer group LG.

In the example of FIG. 9, a “layer group 1”, a “layer group 2”, . . . , and a “layer group G” are described in order from the layer group LG close to the viewpoint VP. The numbers of layers LY that belong to the “layer group 1”, “layer group 2”, . . . , and “layer group G” are described as “m₁”, “m₂”, . . . , and “m_{G}”. The number of layer groups LG and the number of layers LY that belong to each of the layer groups LG vary depending on the scene.

### 3-3. Scene Reproduction Control

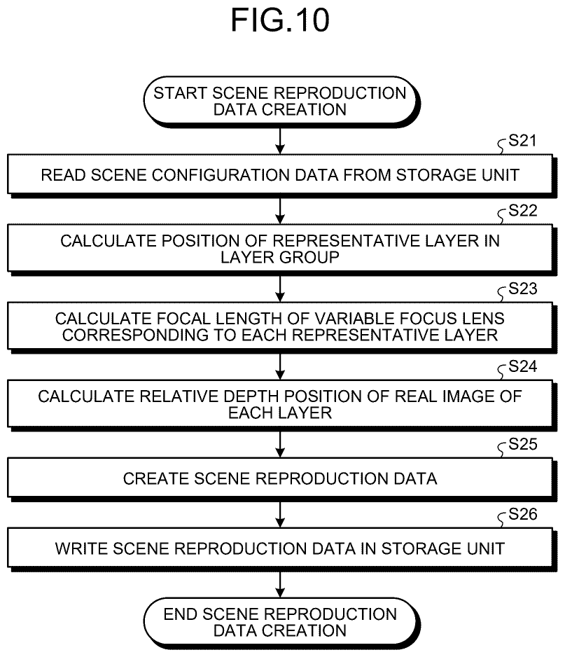

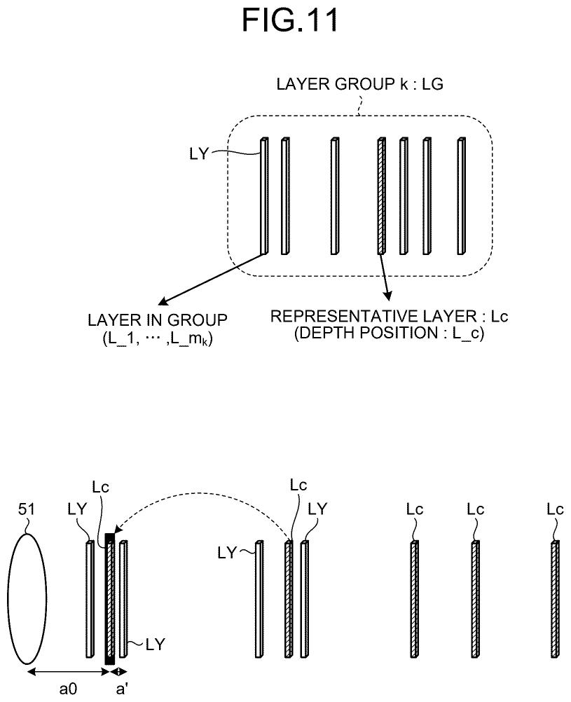

FIG. 10 and FIG. 11 are views illustrating an example of generation processing of the scene reproduction data SR. FIG. 12 is a view illustrating a configuration example of the scene reproduction data SR.

The scene reproduction control unit 21 reads the scene configuration data SC from the storage unit 30 (Step S21). The scene reproduction control unit 21 calculates a depth position of a representative layer L_{c} of each of the layer groups LG (Step S22). The representative layer L_{c} means a virtual layer indicating the reference depth position of the layer group LG. For example, the representative layer L_{c} is set at a barycentric position of the layer group LG.

On an upper side of FIG. 11, a plurality of layers LY included in a “layer group k” is illustrated. The “layer group k” indicates the layer group LG that is the k-th (k is an integer of 1 or larger) closest to the viewpoint VP. The “layer group k” includes mₖ (mₖ is an integer of 1 or larger) layers LY. When it is assumed that the depth position of each of the layers LY is L_1, L_2, . . . , and L_mₖ, the depth position L_c of the representative layer L_{c} is acquired by the following expression (1).

$$L\_c = ( L\_ 1 + L\_ 2 + … + {L\_m}_{k} ) / {m}_{k} \qquad ( 1 )$$

In the above-described example, the representative layer L_{c} is set at the barycentric position of each of the layer groups LG. However, the depth position of the representative layer L_{c} is not limited to the barycentric position of the layer group LG. For example, the representative layer L_{c} may be set at a center position in the depth direction of the layer group LG.

The scene reproduction control unit 21 calculates the focal length FL of the variable focus lens 51 corresponding to each of the representative layers L_{c} (Step S23). For example, the scene reproduction control unit 21 calculates the focal length FL at which a virtual image on the display surface is at the depth position of the representative layer Lc.

For example, it is assumed that a distance between the variable focus lens 51 and the display surface is a, a distance between the display surface and the virtual image is b, and the focal length of the variable focus lens 51 is f. A relationship of the following expression (2) is generally established among the distance a, the distance b, and the focal length f.

$$- 1 / a + 1 / b = 1 / f \qquad ( 2 )$$

In the example of FIG. 11, the distance b is L_c, and the distance a is a0. When these values are substituted into the expression (2), the focal length f is acquired.

For each of the layer groups LG, the scene reproduction control unit 21 calculates a relative depth position of a real image of each of the layers LY with respect to the representative layer L_{c} (Step S24). When the relational expression of the expression (2) is used, the distance b is defined by the depth position of each of the layers LY. The focal length f is a focal length at which the virtual image on the display surface is at the depth position of the representative layer L_{c}. Thus, the distance a is acquired by substitution of such a distance b and focal length f into the expression (2), A relative depth position a′ of each of the layers LY with respect to the representative layer L_{c} is acquired by the following expression (3).

$${a}^{′} = a - a 0 \qquad ( 3 )$$

The scene reproduction control unit 21 generates the scene reproduction data SR by using the focal length f, the relative depth position of each of the layers LY, and the time code tc (Step S25), and writes the scene reproduction data SR in the storage unit 30 (Step S26). For each of the layer groups LG, the scene reproduction data SR defines, for example, the focal length FL of the variable focus lens 51, data (intensity and relative depth position) of each of the layers LY that belong to the layer group LG, and the time code tc.

In the example of FIG. 12, the focal lengths in the “layer group 1”, “layer group 2”, . . . , and “layer group G” are described as “FL₁”, “FL₂”, . . . , and “FL_{G}”. Time codes in the “layer group 1”, “layer group 2”, . . . , and “layer group G” are described as “tc₁”, “tc₂”, . . . , and “tc_{G}”. The focal length FL and the time code tc are set on the basis of the depth position of the representative layer L_{c}.

### 3-4. Wavefront Reproduction Control

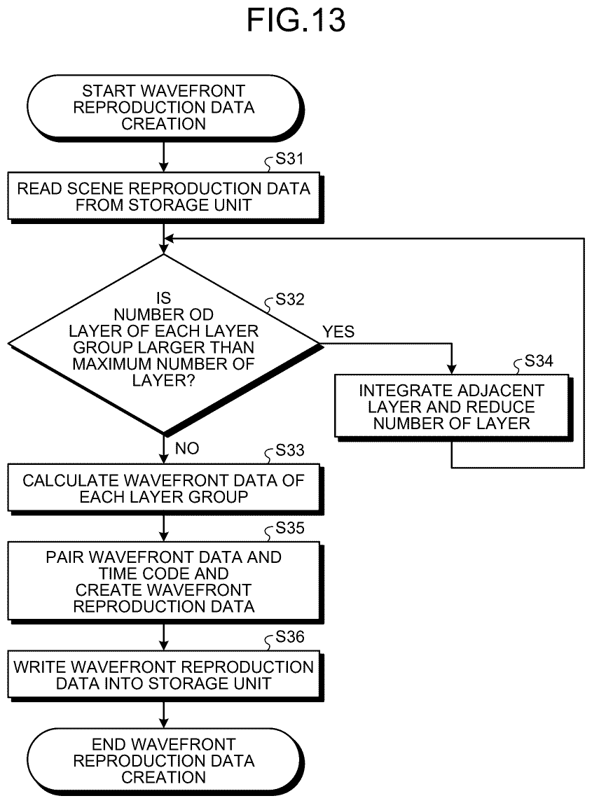

FIG. 13 is a view illustrating an example of generation processing of the wavefront reproduction data WR. FIG. 14 is a view illustrating a configuration example of the wavefront reproduction data WR.

The wavefront reproduction control unit 22 reads the scene reproduction data SR from the storage unit 30 (Step S31). For each of the layer groups LG, the wavefront reproduction control unit 22 detects the number of layers LY that belong to the layer group LG, and determines whether the detected number of layers LY is larger than a preset maximum number of layers (Step S32).

The maximum number of layers means the maximum allowable number of layers (upper limit of the number of layers). For example, the maximum number of layers is set on the basis of the calculation speed of the wavefront reproduction control unit 22. As described above, the wavefront data is generated by utilization of the Rayleigh-Sommerfeld diffraction formula or the like. When the number of layers increases, the amount of calculation increases, and the calculation speed may be insufficient. Thus, the maximum number of layers that can be calculated in time is set as the maximum number of layers, and the number of layers in each of the layer groups LG is controlled to be equal to or smaller than the maximum number of layers.

For example, in a case where the number of layers LY that belong to one layer group LG is larger than the preset maximum number of layers (Step S32: Yes), the wavefront reproduction control unit 22 reduces the number of layers LY by integrating adjacent layers LY (Step S34). Then, the wavefront reproduction control unit 22 returns to Step S32 and compares the reduced number of layers with the maximum number of layers. The wavefront reproduction control unit 22 repeats the processing of Step S32 and Step S34 until the number of layers becomes equal to or smaller than the maximum number of layers.

The processing of reducing the number of layers is performed as follows, for example. First, the wavefront reproduction control unit 22 defines pairs of the adjacent layers LY as layer pairs and calculates layer intervals of all the layer pairs. The layer interval means a distance between the layers LY in the depth direction. The wavefront reproduction control unit 22 specifies a layer pair having the minimum layer interval, and integrates the two layers LY included in the layer pair and generates one virtual integrated layer.

For example, the wavefront reproduction control unit 22 calculates Intensity of the integrated layer as an average value of the Intensity of the two layers LY included in the layer pair. The wavefront reproduction control unit 22 calculates a depth position of the integrated layer as an intermediate depth position between the two layers LY included in the layer pair. The wavefront reproduction control unit 22 can reduce the number of layers LY by one by replacing the layer pair having the minimum layer interval with the integrated layer.

In a case where it is determined that the number of layers is equal to or smaller than the maximum number of layers in all the layer groups LG (Step S32: No), the wavefront reproduction control unit 22 proceeds to the generation processing of the wavefront data WD (Step S33). For example, for each of the layer groups LG, the wavefront reproduction control unit 22 calculates the wavefront data of all the layers LY in the layer group LG. The wavefront reproduction control unit 22 adds the wavefront data of all the layers LY in the layer group LG and generates the wavefront data WD of the layer group LG.

When the wavefront data WD of all the layer groups LG is generated, the wavefront reproduction control unit 22 generates the wavefront reproduction data WR by pairing the wavefront data WD with the time code tc (Step S35). As illustrated in FIG. 14, the wavefront reproduction data WR defines the wavefront data WD and the time code tc for each of the layer groups LG. The wavefront reproduction control unit 22 writes the generated wavefront reproduction data WR in the storage unit 30 (Step S36).

### 3-5. Lens Control

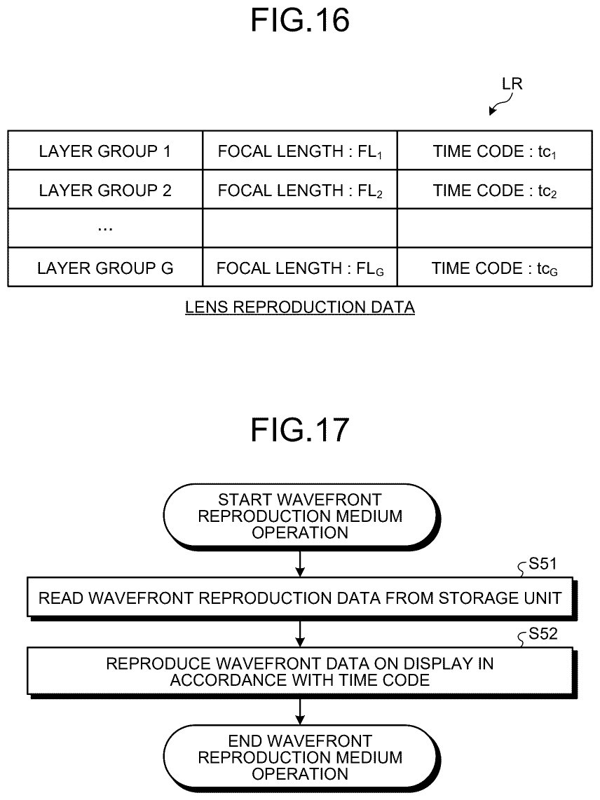

FIG. 15 is a view illustrating an example of generation processing of the lens reproduction data LR. FIG. 16 is a view illustrating a configuration example of the lens reproduction data LR.

The lens control unit 23 reads the scene reproduction data SR from the storage unit (Step S41). The lens control unit 23 extracts information of the focal length FL and the time code tc from the scene reproduction data SR, and generates the lens reproduction data LR (Step S42). As illustrated in FIG. 16, the lens reproduction data LR defines the focal length FL and the time code tc for each of the layer groups LG. The lens control unit 23 writes the generated lens reproduction data LR in the storage unit 30 (Step S43).

### 3-6. Control of a Wavefront Reproduction Medium

FIG. 17 is a view illustrating an example of control of the wavefront reproduction medium 40.

The display driving control unit of the display unit 3 reads the wavefront reproduction data WR from the storage unit 30 (Step S51). The display driving control unit extracts the wavefront data WD and the time code tc of each of the layer groups LG from the wavefront reproduction data WR. The display driving control unit reproduces the wavefront data WD of the corresponding layer group LG on the display 41 in accordance with the time code tc (Step S52).

By reproduction of the wavefront data WD, the interference fringe is displayed on the display surface. When the reference light is emitted to the displayed interference fringe, the reproduced image RI′ is reproduced in the appropriate range PR centered on the display surface. By switching the wavefront data WD in accordance with the time code tc, the reproduced images RI′ of the layer groups LG are switched and displayed in the time-division manner.

### 3-7. Control of a Lens Medium

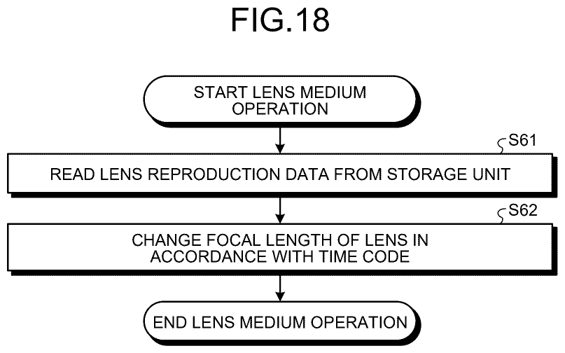

FIG. 18 is a view illustrating an example of control of the lens medium 50.

The lens driving control unit of the display unit 3 reads the lens reproduction data LR from the storage unit 30 (Step S61). The lens driving control unit extracts the focal length FL and the time code tc of each of the layer groups LG from the lens reproduction data LR. The lens driving control unit changes the focal length of the variable focus lens 51 to the focal length FL of the corresponding layer group LG in accordance with the time code tc (Step S62). As a result, the reproduction and rearrangement of the reproduced image RI′ are performed in conjunction with the control of the wavefront reproduction medium 40.

### 4. Effect

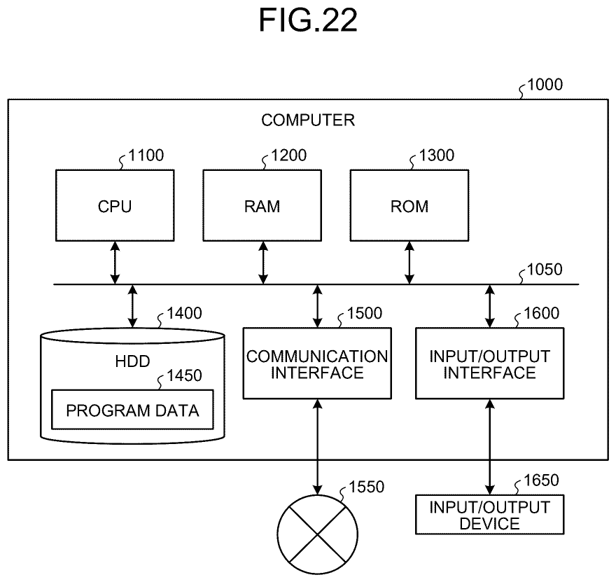

The information processing device 2 includes the wavefront reproduction control unit 22 and the lens control unit 23. The wavefront reproduction control unit 22 reproduces the object area TA to be reproduced in the appropriate range PR in the depth direction in which range the reproduction image quality equal to or higher than the image quality allowable level Qₜₕ can be acquired. The lens control unit 23 moves the reproduced image RI′ reproduced in the appropriate range PR to the depth position of the object area TA. In the information processing method of the present disclosure, processing of the information processing device 2 is executed by a computer 1000 (see FIG. 22). A computer-readable non-transitory storage medium of the present disclosure stores a program for causing the computer 1000 to realize the processing of the information processing device 2.

According to this configuration, the high image quality reproduced image RI′ reproduced in the appropriate range PR is displayed at the appropriate depth position. Thus, natural depth representation with high image quality is acquired.

The information processing device 2 includes the scene reproduction control unit 21. The scene reproduction control unit 21 transforms the coordinate data of the object area TA in such a manner that the object area TA falls within the appropriate range PR. The wavefront reproduction control unit 22 generates the wavefront data WD of the object area TA by using the transformed coordinate data.

According to this configuration, the high image quality reproduced image RI′ can be acquired for the arbitrary object area TA.

The wavefront reproduction control unit 22 sequentially generates the reproduced images RI′ in the appropriate range PR while switching the object areas TA to be reproduced in the depth direction. In accordance with the switching timing of the object area TA, the lens control unit 23 sequentially changes the focal length FL of the variable focus lens 51 that moves the reproduced image RI′.

According to this configuration, a high image quality reproduced image RI can be acquired over a wide depth range.

The information processing device 2 includes the scene analysis unit 11. The scene analysis unit 11 divides a scene to be reproduced into a plurality of layers LY in the depth direction. The scene analysis unit 11 groups the plurality of divided layers LY in the depth direction. The scene analysis unit 11 acquires each of layer groups LG acquired by the grouping as an object area TA.

According to this configuration, the object area TA is specified as one or more layers LY. Thus, calculation of generation and reproduction of the wavefront data WD becomes easier.

The scene analysis unit 11 performs grouping in such a manner that each of the object areas TA becomes an area having a depth equal to or shorter than the depth of the appropriate range PR.

According to this configuration, the high image quality reproduced image RI can be acquired over the wide depth range.

The scene analysis unit 11 widens the layer group range ΔG as the layer group LG is farther from the viewpoint VP at which the scene is reproduced. The layer group range ΔG is a depth range of the layer groups LG.

According to this configuration, the layer group LG farther from the viewpoint VP can have a wider interval between the layers LY. As the layer group LG becomes farther from the viewpoint VP, it becomes difficult to distinguish the individual layers LY when the coordinate transformation is performed. However, when the interval between the layers LY is increased, the layers LY can be easily distinguished from each other.

The scene analysis unit 11 sets the layer group range ΔG in such a manner that the number of layer groups LG is equal to or smaller than the preset maximum number of layer groups.

According to this configuration, the number of times of switching of the focal length FL of the variable focus lens 51 is controlled to the maximum number of layer groups or smaller.

In a case where the number of layers LY that belong to one layer group LG is larger than the preset maximum number of layers, the wavefront reproduction control unit 22 reduces the number of layers LY by integrating the adjacent layers LY.

According to this configuration, a calculation load for generating the wavefront data WD is reduced.

The scene reproduction control unit 21 calculates, for each of the layer groups LG, the focal length FL at the time of reproduction of the layer group LG and the time code tc indicating the timing of changing the focal length FL on the basis of the depth position of the layer group LG.

According to this configuration, the reproduced image RI′ of each of the layer groups LG is reproduced at the appropriate depth position at appropriate timing.

The wavefront reproduction control unit 22 combines the wavefront data of each of the layers LY on the basis of the relative position of each of the layers LY in each of the layer groups LG. The wavefront reproduction control unit 22 calculates the wavefront data acquired by the combination as the wavefront data WD of the layer group LG.

According to this configuration, it is possible to generate the wavefront data WD of the layer groups LG by diverting a known generation algorithm of the wavefront data WD.

Note that the effects described in the present description are merely examples and are not limitations, and there may be another effect.

### 5. First Modification Example

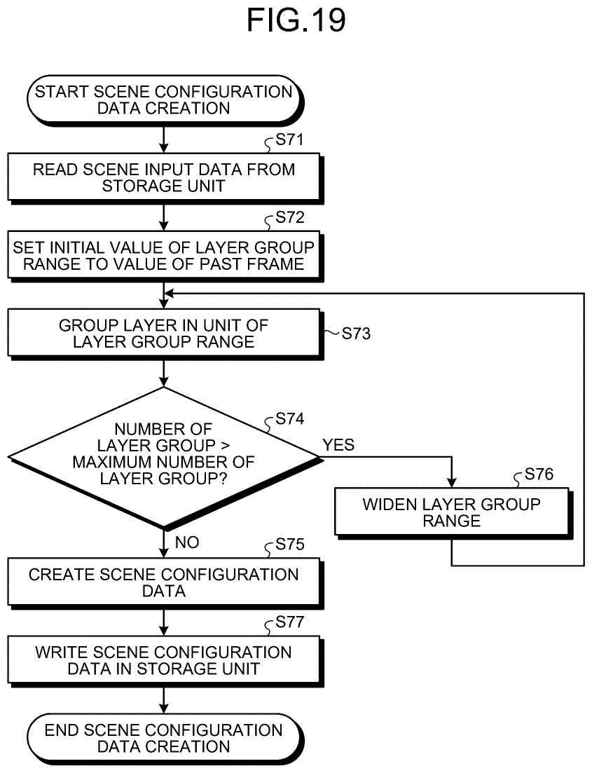

FIG. 19 is a view illustrating a modification example of generation processing of scene configuration data SC.

The present modification example is different from the above-described embodiment in a point that the layer group range ΔG is set in consideration of temporal continuity with a past frame. Step S71, and S73 to S77 in FIG. 19 are the same as Step S11, and S13 to S17 in FIG. 7. Only Step S72 is different from FIG. 7.

The scene analysis unit 11 sets an initial value of a layer group range ΔG to a value of a past frame (Step S72). As a result, the scene analysis unit 11 can reflect a set value of the layer group range ΔG set in the latest frame on a set value of the layer group range ΔG of a current frame. According to this configuration, a time variation of the layer group range ΔG is controlled. Thus, deterioration in image quality due to a high-speed variation of a reproduced image RI can be controlled.

### 6. Second Modification Example

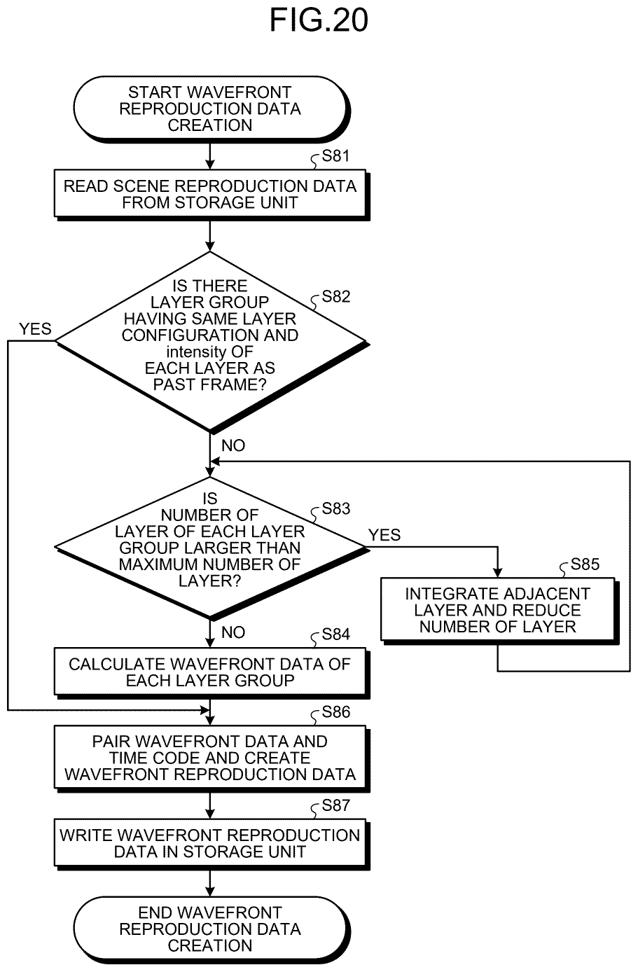

FIG. 20 is a view illustrating a modification example of generation processing of wavefront reproduction data WR.

The present modification example is different from the above-described embodiment in a point that, in the generation processing of the wavefront data WD, what has a small difference in intensity from a past frame is not recalculated. Step S81, and S83 to S87 in FIG. 20 are the same as Step S31 to S36 in FIG. 13. Only Step S82 is different from FIG. 13.

From the latest frame, the wavefront reproduction control unit 22 extracts, as an invariable layer group, a layer group LG in which a layer configuration (number and position of layers LY) and Intensity of each of the layers do not change. The wavefront reproduction control unit 22 uses wavefront data WD of the invariable layer group calculated most recently as the wavefront data WD of the invariable layer group of a current frame.

For example, the wavefront reproduction control unit 22 determines whether there is a layer group LG (invariable layer group) in which the layer configuration and the intensity of each of the layers LY are the same as those of the past frame (Step S82). In a case where there is the invariable layer group (Step S82: Yes), the wavefront reproduction control unit 22 does not generate the wavefront reproduction data for the invariable layer group and performs the processing in and after Step S86.

In Step S86, for the invariable layer group, the wavefront reproduction control unit 22 diverts the wavefront data WD and a time code tc of the past frame as they are as the wavefront data WD and a time code tc of the current frame. According to this configuration, a calculation load for generating the wavefront data WD is reduced.

### 7. Third Modification Example

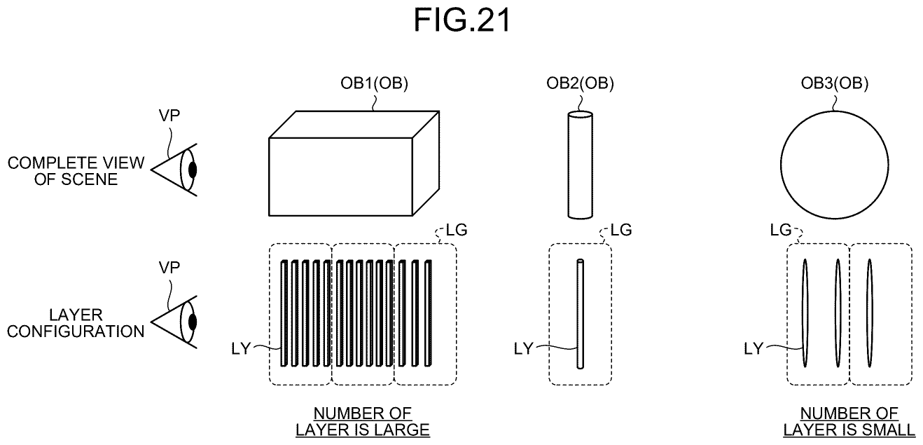

FIG. 21 is a view illustrating a modification example of generation processing of wavefront reproduction data WR.

The present modification example is different from the above-described embodiment in a point that a layer LY of a layer group LG that is not important is selectively reduced in the integration processing of Step S34. The scene analysis unit 11 calculates importance of each of layer groups LG on the basis of an analysis result of a scene. The wavefront reproduction control unit 22 preferentially reduces the number of layers LY of a layer group LG of low importance. According to this configuration, deterioration in image quality of an important layer group LG can be controlled.

A criterion of the importance can be arbitrarily set. For example, an object OB located ahead of a line of sight, an object OB closest to a viewpoint VP, an object OB located at a center of a screen, and an object OB having a large size, and the like are set as objects with high importance. A layer group LG included in such an object OB with high importance is detected as the layer group LG with high importance.

In the example of FIG. 21, a layer group LG included in an object OB1 closest to the viewpoint VP has high importance. Layer groups LG included in an object OB2 and an object OB3 far from the viewpoint VP have low importance. The layer group LG with high importance is set to have a larger maximum number of layers than the layer groups LG with low importance. As a result, it is possible to control an increase in the total number of layers while improving resolution in a depth direction of the important object OB1.

When the maximum number of layers is reduced to 1, the minimum number of layers is 1. When the number of layers is one, it is only necessary to display a 2D image, and complicated wavefront reproduction calculation becomes unnecessary. Thus, an amount of calculation is dramatically reduced, and the layers LY assigned to the important object OB1 can be increased accordingly.

### 8. Hardware Configuration Example

FIG. 22 is a view illustrating a hardware configuration example of the information processing device 2.

Information processing of the information processing device 2 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of programs (program data 1450) stored in the ROM 1300 or the HDD 1400, and controls each unit. For example, the CPU 1100 expands the programs, which are stored in the ROM 1300 or the HDD 1400, in the RAM 1200 and executes processing corresponding to the various programs.

The ROM 1300 stores a boot program such as a basic input output system (BIOS) executed by the CPU 1100 during activation of the computer 1000, a program that depends on hardware of the computer 1000, and the like.

The HDD 1400 is a computer-readable non-transitory recording medium that records the programs executed by the CPU 1100, data used by the programs, and the like in a non-transitory manner. Specifically, the HDD 1400 is a recording medium that records an information processing program according to the embodiment as an example of the program data 1450.

The communication interface 1500 is an interface with which the computer 1000 is connected to an external network 1550 (such as the Internet). For example, the CPU 1100 receives data from another equipment or transmits data generated by the CPU 1100 to another equipment via the communication interface 1500.

The input/output interface 1600 is an interface to connect an input/output device 1650 and the computer 1000. For example, the CPU 1100 receives data from an input device such as a keyboard or a mouse via the input/output interface 1600. Furthermore, the CPU 1100 transmits data to an output device such as a display device, speaker, or printer via the input/output interface 1600. Also, the input/output interface 1600 may function as a medium interface that reads a program or the like recorded on a predetermined recording medium (medium). The medium is, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 2 according to the embodiment, the CPU 1100 of the computer 1000 realizes a function each of above-described units by executing the information processing program loaded on the RAM 1200. In addition, the HDD 1400 stores the information processing program, various models, and various kinds of data according to the present disclosure. Note that the CPU 1100 reads the program data 1450 from the HDD 1400 and performs execution thereof. However, these programs may be acquired from another device via the external network 1550 in another example.

### [Supplementary Note]

Note that the present technology can also have the following configurations.

(1)

An information processing device comprising:
a wavefront reproduction control unit that reproduces an object area to be reproduced in an appropriate range in a depth direction in which range reproduction image quality equal to or higher than an image quality allowable level is acquired; and
a lens control unit that moves a reproduced image reproduced in the appropriate range to a depth position of the object area.
   (2)

The information processing device according to (1), further comprising
a scene reproduction control unit that transforms coordinate data of the object area in such a manner that the object area falls within the appropriate range, wherein
the wavefront reproduction control unit generates wavefront data of the object area by using the transformed coordinate data.
   (3)

The information processing device according to (2), wherein
the wavefront reproduction control unit sequentially generates the reproduced image in the appropriate range while switching the object area to be reproduced in the depth direction, and
the lens control unit sequentially changes a focal length of a variable focus lens that moves the reproduced image in accordance with switching timing of the object area.
   (4)

The information processing device according to (3), further comprising
a scene analysis unit that divides a scene to be reproduced into a plurality of layers in the depth direction, groups the plurality of layers in the depth direction, and acquires each of layer groups acquired by the grouping as the object area.
   (5)

The information processing device according to (4), wherein
the scene analysis unit performs the grouping in such a manner that the object area becomes an area having a depth equal to or shorter than a depth of the appropriate range.
   (6)

The information processing device according to (4) or (5), wherein
the scene analysis unit widens a depth range of the layer groups as the layer groups become farther from a viewpoint at which the scene is reproduced.
   (7)

The information processing device according to any one of (4) to (6), wherein
the scene analysis unit sets a depth range of the layer groups in such a manner that number of layer groups becomes equal to or smaller than preset maximum number of layer groups.
   (8)

The information processing device according to (7), wherein
the scene analysis unit reflects a set value of the depth range of the layer groups, which value is set in a latest frame, on a set value of the depth range of the layer groups of a current frame.
   (9)

The information processing device according to any one of (4) to (8), wherein
in a case where number of layers that belong to one of the layer groups is larger than preset maximum number of layers, the wavefront reproduction control unit reduces the number of layers by integrating adjacent layers.
   (10)

The information processing device according to (9), wherein
the scene analysis unit calculates importance of each of the layer groups on a basis of an analysis result of the scene, and
the wavefront reproduction control unit preferentially reduces the number of layers in a layer group with low importance.
   (11)

The information processing device according to any one of (4) to (10), wherein
the scene reproduction control unit calculates, for each of the layer groups, the focal length in reproduction of the layer group and a time code indicating timing of changing the focal length on a basis of the depth position of the layer group.
   (12)

The information processing device according to (11), wherein
the wavefront reproduction control unit combines wavefront data of each of the layers on a basis of a relative position of each of the layers in each of the layer groups, and calculates the wavefront data acquired by the combination as wavefront data of the layer group.
   (13)

The information processing device according to (12), wherein
the wavefront reproduction control unit extracts, as an invariable layer group, a layer group in which a layer configuration and Intensity of each of the layers are not changed from these of a latest frame, and uses wavefront data of the invariable layer group, which wavefront data is calculated most recently, as the wavefront data of the invariable layer group of a current frame.
   (14)

An information processing method executed by a computer, the method comprising:
reproducing an object area to be reproduced in an appropriate range in a depth direction in which range reproduction image quality equal to or higher than an image quality allowable level is acquired; and
moving a reproduced image reproduced in the appropriate range to a depth position of the object area.
   (15)

A computer-readable non-transitory storage medium that stores a program causing a computer to realize
reproducing an object area to be reproduced in an appropriate range in a depth direction in which range reproduction image quality equal to or higher than an image quality allowable level is acquired, and
moving a reproduced image reproduced in the appropriate range to a depth position of the object area.

### REFERENCE SIGNS LIST

2 INFORMATION PROCESSING DEVICE
11 SCENE ANALYSIS UNIT
21 SCENE REPRODUCTION CONTROL UNIT
22 WAVEFRONT REPRODUCTION CONTROL UNIT
23 LENS CONTROL UNIT
51 VARIABLE FOCUS LENS
FL FOCAL LENGTH
LG LAYER GROUP
LY LAYER
PR APPROPRIATE RANGE
Qₜₕ IMAGE QUALITY ALLOWABLE LEVEL
RI′ REPRODUCED IMAGE
TA OBJECT AREA
tc TIME CODE
VP VIEWPOINT
WD WAVEFRONT DATA

1. An information processing device comprising:
a wavefront reproduction control unit that reproduces an object area to be reproduced in an appropriate range in a depth direction in which range reproduction image quality equal to or higher than an image quality allowable level is acquired; and
a lens control unit that moves a reproduced image reproduced in the appropriate range to a depth position of the object area.

2. The information processing device according to claim 1, further comprising
a scene reproduction control unit that transforms coordinate data of the object area in such a manner that the object area falls within the appropriate range, wherein
the wavefront reproduction control unit generates wavefront data of the object area by using the transformed coordinate data.

3. The information processing device according to claim 2, wherein
the wavefront reproduction control unit sequentially generates the reproduced image in the appropriate range while switching the object area to be reproduced in the depth direction, and
the lens control unit sequentially changes a focal length of a variable focus lens that moves the reproduced image in accordance with switching timing of the object area.

4. The information processing device according to claim 3, further comprising
a scene analysis unit that divides a scene to be reproduced into a plurality of layers in the depth direction, groups the plurality of layers in the depth direction, and acquires each of layer groups acquired by the grouping as the object area.

5. The information processing device according to claim 4, wherein
the scene analysis unit performs the grouping in such a manner that the object area becomes an area having a depth equal to or shorter than a depth of the appropriate range.

6. The information processing device according to claim 4, wherein
the scene analysis unit widens a depth range of the layer groups as the layer groups become farther from a viewpoint at which the scene is reproduced.

7. The information processing device according to claim 4, wherein
the scene analysis unit sets a depth range of the layer groups in such a manner that number of layer groups becomes equal to or smaller than preset maximum number of layer groups.

8. The information processing device according to claim 7, wherein
the scene analysis unit reflects a set value of the depth range of the layer groups, which value is set in a latest frame, on a set value of the depth range of the layer groups of a current frame.

9. The information processing device according to claim 4, wherein
in a case where number of layers that belong to one of the layer groups is larger than preset maximum number of layers, the wavefront reproduction control unit reduces the number of layers by integrating adjacent layers.

10. The information processing device according to claim 9, wherein
the scene analysis unit calculates importance of each of the layer groups on a basis of an analysis result of the scene, and
the wavefront reproduction control unit preferentially reduces the number of layers in a layer group with low importance.

11. The information processing device according to claim 4, wherein
the scene reproduction control unit calculates, for each of the layer groups, the focal length in reproduction of the layer group and a time code indicating timing of changing the focal length on a basis of the depth position of the layer group.

12. The information processing device according to claim 11, wherein
the wavefront reproduction control unit combines wavefront data of each of the layers on a basis of a relative position of each of the layers in each of the layer groups, and calculates the wavefront data acquired by the combination as wavefront data of the layer group.

13. The information processing device according to claim 12, wherein
the wavefront reproduction control unit extracts, as an invariable layer group, a layer group in which a layer configuration and Intensity of each of the layers are not changed from these of a latest frame, and uses wavefront data of the invariable layer group, which wavefront data is calculated most recently, as the wavefront data of the invariable layer group of a current frame.

14. An information processing method executed by a computer, the method comprising:
reproducing an object area to be reproduced in an appropriate range in a depth direction in which range reproduction image quality equal to or higher than an image quality allowable level is acquired; and
moving a reproduced image reproduced in the appropriate range to a depth position of the object area.

15. A computer-readable non-transitory storage medium that stores a program causing a computer to realize
reproducing an object area to be reproduced in an appropriate range in a depth direction in which range reproduction image quality equal to or higher than an image quality allowable level is acquired, and
moving a reproduced image reproduced in the appropriate range to a depth position of the object area.
